(19) United States
(12) Patent Application Publication
(10) Pub. No.: US 2005/0185855 A1
(43) Pub. Date: Aug. 25, 2005

(54) Image outputting method, image reading method, image outputting apparatus and image reading apparatus

(75) Inventor: Atsushi Suzuki, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/060,238

(22) Filed: Feb. 17, 2005

(30) Foreign Application Priority Data
Feb. 25, 2004 (JP) JP2004-049417

(51) Int. Cl. G06K 9/40

(52) U.S. Cl. 382/274

(57) ABSTRACT

An image outputting apparatus comprises a plurality of outputting elements for outputting a correction image, an image reading apparatus for obtaining read-out information, and a first correction processor for obtaining a correction amount of an output density based on the reading information, wherein the first correction processor calculates a first correction value for correcting a first reference input signal corresponding to a predetermined reference output density to a predetermined second reference input signal and a second correction value to be used for correcting an approximation function to a reference input-output function, the approximation function being obtained from a virtual input-output function showing an input-output characteristic corrected by the first correction value, under a condition an output density becomes the reference output density when an input signal is the second reference signal, and corrects an input signal by using the first correction and second correction values.

### FIELD OF THE INVENTION

The present invention relates to an image outputting method to output images by means of a plurality of output elements and an image outputting apparatus, and to an image reading method to acquire read-out information from images by means of a plurality of light-receiving elements and an image reading apparatus.

### BACKGROUND OF THE INVENTION

As a recording head of an image outputting apparatus that outputs images on a recording medium such as a sliver halide photosensitive material, there has been one equipped with recording elements (outputting elements) of a light amount controlling type arranged in a form of an array.

In general, each of plural recording elements constituting the array has dispersion in its own light-emitting characteristic, namely, in its recording characteristic at each output density, and the dispersion causes unevenness of gradation on images in the direction of arrangement of recording elements.

As a technology to correct the dispersion, there is proposed a method to obtain an amount of emitted light corresponding to a prescribed output density for each recording element, and to obtain a correction amount for an amount of emitted light of each recording element, namely, the so-called shading correction value, based on the data of the emitted light (for example, see Patent Document 1).

(Patent Document 1) TOKKAIHEI No. 8-230235

However, in the correcting method mentioned above, the dispersion stated above cannot be corrected when the shading correction value is changed depending on a difference of output density.

It is therefore considered to obtain a shading correction value for each output density for each recording element. However, when this method is used, an amount of data turns out to be massive, because shading correction values in quantity equivalent to the number obtained by multiplying the number of recording elements by the number of output density (the number of gradations). Further, since it is difficult to keep the measurement accuracy in the case of obtaining the aforesaid data of light amount to be excellent at all output densities, the measurement accuracy falls at specific output density, resulting in the correction conducted by the shading correction value having errors.

The problem of this kind is also caused in the case of acquiring read-out information from images by plural light-receiving elements each having dispersion in light-receiving characteristic.

### SUMMARY OF THE INVENTION

An object of the invention is to provide an image outputting method capable of correcting dispersion of output characteristics of plural output elements at high accuracy with an amount of data less than conventional one, and an image output apparatus, and an image reading method capable of correcting dispersion of light-receiving characteristics of plural light-receiving elements at high accuracy and with an amount of data less that conventional one, and an image reading apparatus.

One of the embodiment of the present invention is an image outputting apparatus equipped with a plurality of outputting elements which output images for correction, an image reading apparatus that acquires read-out information from the images for correction, and with the first correction processor that obtains an amount of correction of output density of each outputting element based on the read-out information, wherein the first correction processor calculates the first correction value to correct the first reference input signal corresponding to the prescribed reference output density to the prescribed second reference input signal, and the second correction value to correct the approximate function obtained from the virtual input-output function showing input-output characteristics in the case of correcting by the first correction value, under the condition that the output density turns out to be the reference output density when the input signal is the second reference input signal to the prescribed reference input-output function, about each outputting element, and corrects input signals by the use of the first correction value and the second correction value.

According to the embodiment of the present invention described above, the input-output function of the outputting element is approximated to the reference input-output function, namely, the dispersion of outputting characteristics of the outputting element is corrected, because the first correction value and the second correction value are used for correction of the input signal. Accordingly, the dispersion can be corrected by using two correction values including the first correction value and the second correction value, thereby, the dispersion can be corrected without using correction values for each output density concerning each output element, which is different from the traditional way. In other words, the dispersion can be corrected by an amount of data that is less than that in the past.

It is further possible to use only read-out information at the output density having high measuring accuracy because it is not always necessary to use read-out information for all output densities, which is different from the past. It is therefore possible to correct with correction values which are free from errors, namely, it is possible to correct at a higher precision than in the past.

Another embodiment of the present invention is the image outputting apparatus, wherein the first correction processor calculates the virtual input-output function by normalizing the input-output function showing input-output characteristics of each outputting element with output density corresponding to the first reference input signal.

According to the embodiment of the present invention described above, the first correction value and the second correction value do not interact each other because the virtual input-output function is calculated by normalizing the input-output function that shows input-output characteristics of each output element by the use of output density corresponding to the first reference input signal. Therefore, the second correction value can be calculated either before or after the calculation of the first correction value, in other words, the first correction value and the second correction value can be calculated independently. Accordingly, one of the first correction value and the second correction value can be changed while the other is fixed, thus, the correction accuracy can be enhanced convergently by calculating the first correction value or the second correction value based on the result of the preceding calculation.

Another embodiment of the present invention is the image outputting apparatus, wherein the first correction processor stores the calculated second correction value and uses it for succeeding calculation of the second correction value.

According to the embodiment of the present invention described above, the correction accuracy by the second correction value can be enhanced convergently because the calculated second correction value is used for succeeding calculation of the second correction values.

Another embodiment of the present invention is the image outputting apparatus, wherein the second correction value is a value obtained by multiplying the calculated second correction value by the ratio of a tilt of the approximate function to a tilt of a linear area of the reference input-output function.

According to the embodiment of the present invention described above, it is possible to calculate the second correction value easily, compared with an occasion to use a higher-order coefficient, because a ratio of a tilt of the approximate function to a tilt of a linear area of the reference input-output function is used. Further, it is possible to enhance convergently a precision of correction by the second correction value, by using the second correction value resulting from the preceding calculation.

Another embodiment of the present invention is the image outputting apparatus, wherein the second correction value represents a ratio of a tilt of the approximate function to a tilt of the linear area of the reference input-output function.

According to the embodiment of the present invention described above, it is possible to calculate the second correction value easily, compared with an occasion to use a higher-order coefficient, since a ratio of a tilt of the approximate function to a tilt of a linear area of the reference input-output function is used as the second correction value.

Another embodiment of the present invention is the image outputting apparatus, wherein the second reference input signal and the reference output density represent a value obtained from the linear area of the reference input-output function.

According to the embodiment of the present invention described above, a value obtained from the linear area of the reference input-output function, namely, from the area where the measuring accuracy for output density is high is used, as the second reference input signal and reference output density, and thereby, the dispersion can be corrected at higher accuracy, which is different from the occasion where a value obtained from the non-linear area is used. Further, images having no uneven density visually can be outputted because output densities can be made uniform between output elements in the density area where an influence of uneven density is visually great.

Another embodiment of the present invention is the image outputting apparatus, wherein the outputting element is a light-emitting element that records images on a photosensitive material.

According to the embodiment of the present invention described above, when images are outputted on a photosensitive material by a light-emitting element, it is possible to obtain an effect that is the same as that in the invention described above.

### BRIEF DESCRIPTION OF THE DRAWINGS

FIG. 1 is a perspective view showing a schematic structure of an image outputting apparatus.

FIG. 2 is a diagram for illustrating an arrangement of a recording element in a recording head, and for illustrating an arrangement of CCD in a flatbed scanner.

FIG. 3 is a diagram showing an image outputting method relating to the invention.

FIG. 4 is a diagram showing a patch image for correction.

FIG. 5 is a diagram showing procedures for calculating the first correction value.

FIG. 6(a) is a diagram showing procedures for calculating reference light amount value _{z} (xₒ, i), and FIG. 6(b) is a diagram showing procedures for calculating reference density value _{w} (xₒ, i).

FIG. 7 is a diagram showing procedures for calculating the second correction value c (i).

FIG. 8 is a diagram showing an image reading method relating to the invention.

FIG. 9 is a diagram showing procedures for calculating the third correction value.

FIG. 10 is a diagram showing procedures for calculating the fourth correction value f (i).

### DETAILED DESCRIPTION OF THE INVENTION

Embodiments of the invention will be explained in detail as follows, referring to the drawings to which, however, a scope of the invention is not limited.

### First Embodiment

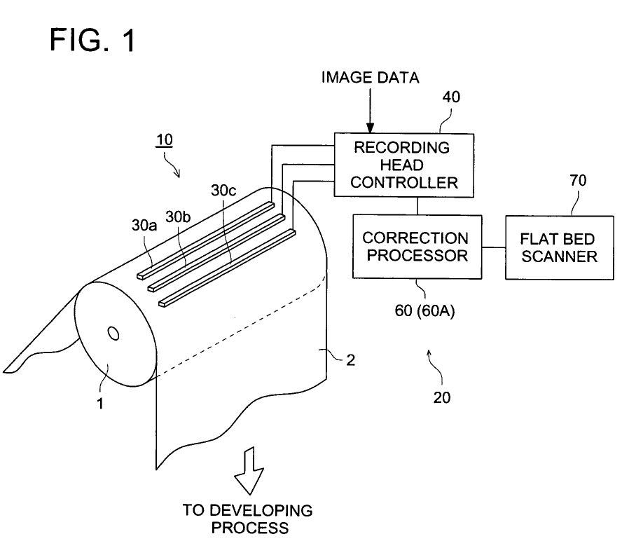

A schematic structure of image outputting apparatus 10 relating to the invention is shown in FIG. 1. As shown in this diagram, the image outputting apparatus 10 is equipped with supporting drum 1.

The supporting drum 1 is rotated by an unillustrated driving source, to transport color photograph printing paper (hereinafter referred to as printing paper) 2 that is drawn out of a roll (not shown) in the arrow direction. AS printing paper 2, a silver halide photosensitive material is used. A developing unit (not shown) is arranged at a place to which the printing paper 2 is transported. Incidentally, the printing paper 2 may further be of a cut-sheet type without being limited to a roll sheet type. Further, a transporting means for the printing paper 2 may further be other means such as a transporting belt, without being limited to supporting drum 1.

On the upper part of the supporting drum 1, there are arranged recording heads 30a-30c each forming a latent image of a color image on the printing paper 2 by emitting light.

The recording heads 30a-30c are those for recording respectively red color, green color and blue color. Incidentally, as the recording heads 30b and 30c, there is used a vacuum fluorescent recording head (Vacuum Fluorescent Print Head: VFPH) which can easily be color-separated by a color filter on a basis of relatively high luminance and quick response.

On each of these recording heads 30a-30c, there are arranged a plurality of recording elements (outputting elements) 3, in a form of an array. Incidentally, as recording elements 3 of recording head 30a, LED (Light Emitting Diode) is used.

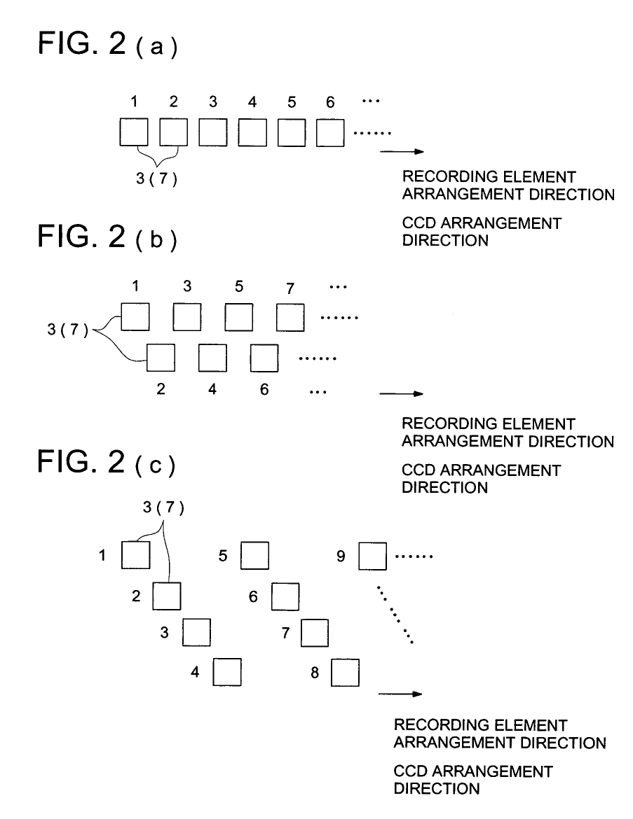

In this case, an array of recording elements 3 may either be in a single row as shown in FIG. 2(a) or be in plural rows as shown in FIGS. 2(b) and 2(c). Further, the direction of arrangement for recording elements 3 means the direction in which more recording elements 3 are arranged as shown with arrows in FIGS. 2(a)-2(c). To distinguish the recording elements 3 for convenience' sake, let it be assumed that each recording element 3 is given its own number, starting from 1.

Recording heads 30a-30c are respectively connected to recording head control section 40.

The recording head control section 40 is one to control the recording heads 30a-30c so that image data for each of RGB colors may be outputted at the prescribed position on printing paper 2.

To the recording head control section 40, there is connected correction processor 60 (first correction processor).

The correction processor 60 is one to correct light-emitting characteristics (recording characteristics) of each recording element 3 in recording heads 30a-30c. The correction processor 60 is arranged to calculate an amount of correction of an amount of light-emitting for recording elements 3 and to output it to the recording head control section 40. The correction processor 60 is further arranged to store various parameters necessary for correction, including specifically, the first correction value H (i) and the second correction value c (i) which will be described later.

Flatbed scanner 70 is connected to the correction processor 60.

The flatbed scanner 70 is an apparatus to read images developed by the developing unit, and apparatus is composed of plural CCDs (Charge Coupled Device) (light-receiving elements, see FIG. 2) 7, light source (not shown) and A/D converter (not shown).

The flatbed scanner 70 is arranged so that reflected light resulting from the image that is placed on the original table and is irradiated by light emitted from the light source may be converted into an electric signal by the CCDs 7, and thereby read-out information may be acquired. Then, the flatbed scanner 70 makes the A/D converter to convert the acquired read-out information into digital data to transmit to the correction processor 60 as image read-out information. The image read-out information mentioned here is information that brings recording elements 3 which correspond to positions of images thus read, CCD 7 and density data each showing density of each color component of RGM three colors, into connection.

The CCD 7 are arranged in a form of an array in the same direction as in the arrangement of recording elements 3, as illustrated in FIGS. 2(a)-(c). To distinguish CCD 7 for convenience' sake, let it be assumed that each CCD 7 is given its own number, starting from 1.

Next, the image outputting method relating to the invention will be explained.

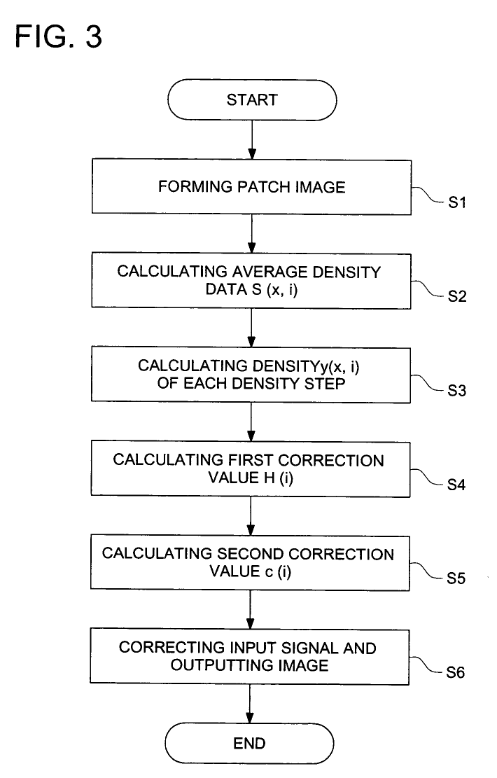

FIG. 3 is a flow chart showing an image outputting method in the present embodiment.

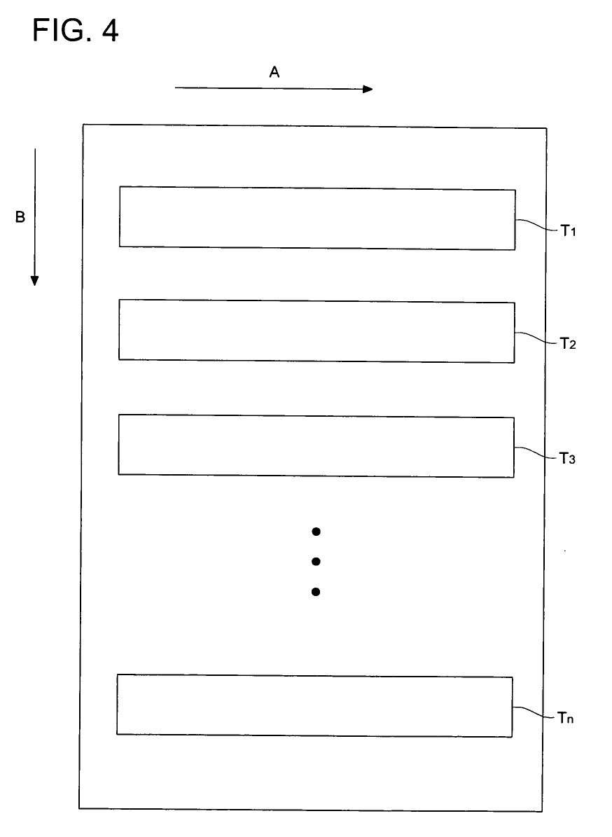

As shown in this drawing, image outputting apparatus 10 outputs a patch image (image for correction) for correction of light exposure shown in FIG. 4 on a printing paper by means of recording heads 30a-30c, and visualizes it by means of the developing unit (step S1). In this case, images corresponding respectively to density steps T₁-Tₙ in FIG. 4 are solid images outputted in densities which are different stepwise. Direction A is a direction for arrangement of recording elements 3, while, direction B is a direction for image output.

Next, the flatbed scanner 70 acquires read-out information from the patch image, and from the read-out information, the correction processor 60 calculates average density data S (x, i) (x represents input signal corresponding to each density step and i represents a recording element number) in the direction B in each density step (step S2). Due to this, there are calculated density data which are not affected by uneven density that is caused by noises.

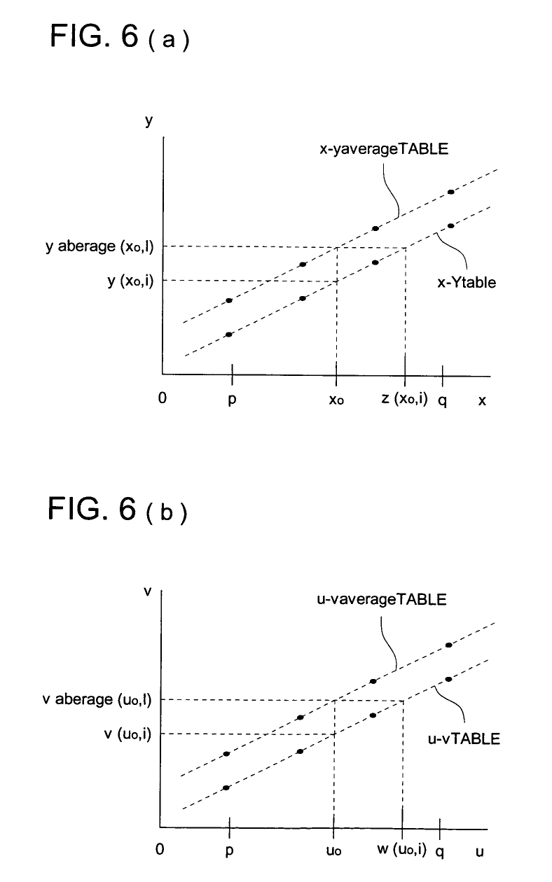

Then, the correction processor 60 calculates density of each density step (output density) y (x, i) based on the following expression (1) (step S3). Equally, the correction processor 60 calculates reference density y (x₀, i) (see FIG. 6(a)) of reference density step Tₓₒ positioned between density step Tₚ and density step T_{q} (xo represents reference input signal (second reference input signal) shown by xo=(xₚ+x_{q})/2, and “ₚ” and “_{q}” represent subscripts showing density steps). This reference density y (x₀, i) is density that varies depending on recording element 3. Incidentally, p and q are integers satisfying respectively 1≦p≦n and 1≦q≦n, and for example, 3 can be used as p and 6 can be used as q. Further, the reference density step Tₓₒ may also be a virtual density step without being limited to the density step outputted actually;
y(x, i)=−log (S(x, i)/K) (1)
wherein, K represents a constant determined depending on the flatbed scanner 70.

Next, the correction processor 60 calculates first correction value H (i) for correcting input signalₓ corresponding to average reference density (reference output density)y_{Average} (xo, I) which will be described later into reference input signalₓₒ (step S4). Incidentally, in the step S4, the input signalₓ is a value that satisfies p≦x≦q.

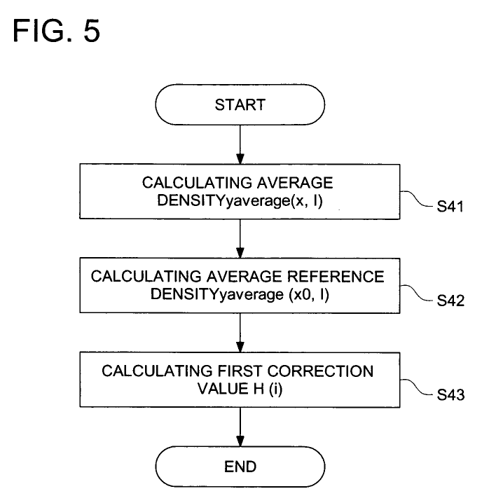

Specifically, as shown in FIG. 5, the correction processor 60 first calculates an average value of density y (x, i) (hereinafter referred to as average density) y_{Average} (x, I) (wherein, I represents a subscript showing an average of plural recording elements 3) for recording element 3 within a prescribed range in the direction A (see FIG. 4), for each of density steps Tₚ-T_{q}.

Next, as shown in FIG. 6(a), the correction processor 60 prepares an x-y_{Average} table and calculates, from the table, a value of average density y_{Average} corresponding to the reference input signal xₒ interpolatively (step S42). In this case, average reference density y_{Average} (xₒ, I) and the reference input signal xₒ represent a value obtained from a linear area of an x-y_{Average} table described later, namely, a value obtained from an area where accuracy of measuring density by flatbed scanner 70 is high. Incidentally, FIG. 6 (a) illustrates only an x-y table about one recording element 3, for convenience' sake.

Further, the correction processor 60 calculates input signal x that corresponds to average reference density y_{Average} (xₒ, I) about each recording element 3, by using an x-y table, to make it to be a reference value of amount of light (first reference input signal) z (xₒ, i). Then, the correction processor 60 calculates first correction value H (i) (=xₒ/z (xₒ, i)) based on the result of the aforesaid calculation (step S43). Incidentally, as the processing for the steps of S1-S4, the processing disclosed in TOKKAIHEI No. 10-811 or 9-131918 may also be used.

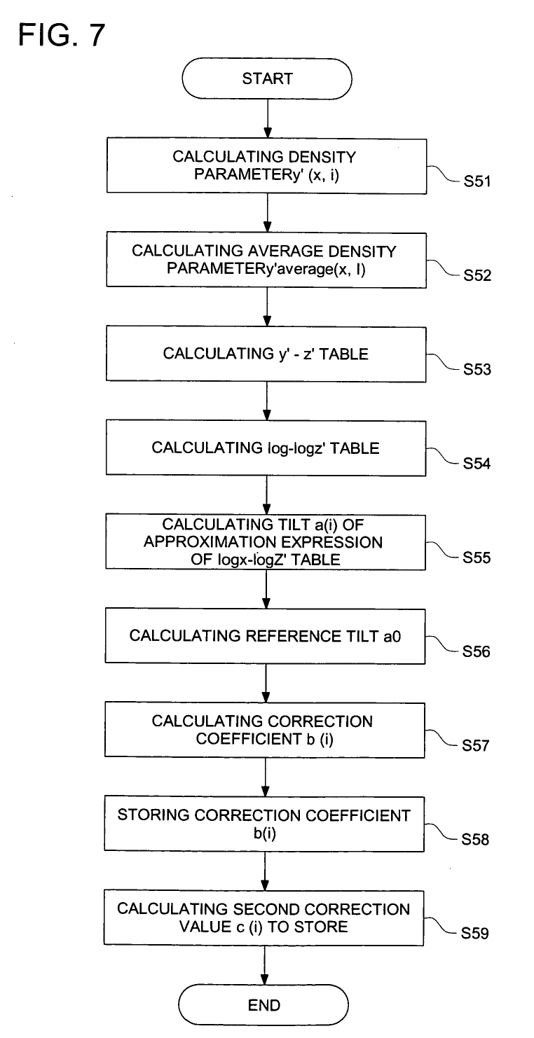

After calculating the first correction value H (i), the correction processor 60 calculates second correction value c (i) for converting tilt a (i) of an approximate function of a virtual input-output function in the case of correcting the input-output function of each recording element 3 with the first correction value H (i) as shown in FIG. 7 into the reference tilt aₒ (tilt of reference input-output function) (step S5). Incidentally, in the following steps, input signal x is not limited to the value satisfying p≦x≦q.

To be concrete, the correction processor 60 first normalizes density y (x, i) with reference density y (xₒ i) based on the following expression (2), and calculates normalized density (hereinafter referred to as a density parameter)y′ (x, i) (step S51)
y′(x, i)=y(x, i)−y(xₒ, i)+y_{Average}(xₒ, I) (2)

Owing to this, a virtual input-output function in the case of correcting an x-y table representing input-output function of recording element 3 with the first correction value H (i) is calculated as an x-y′ table.

Then, the correction processor 60 calculates an average value (hereinafter referred to an average density parameter) y′_{Average} (x, I) of density parameter y′ (x, i) concerning recording elements 3, within a prescribed range (step S52). Incidentally, average density parameter y′_{Average} (x, I) may also be an average concerning all recording elements 3.

Then, the correction processor 60 calculates a y′-z′ table showing the relationship between the density parameter y′ and a value of light amount (hereinafter referred to as a light amount parameter) z′ corresponding to density parameter y′ (step S53). Further, the correction processor 60 uses this y′-z′ table to calculate light amount parameter z (x, i) corresponding to density parameter y′ (x, i) of each input signal x and each recording element 3. Still further, the correction processor 60 calculates an x-z′ table by replacing density parameter y′ of the y′-z′ table with input signal x.

Then, the correction processor 60 calculates a log x-log z′ table from the x-z′ table concerning each recording element 3 (step S54), and calculates an approximate function (approximate expression) of the log x-log z′ table by using the least-squares method. In this case, the density parameter y′ (x, i) is made to be average reference density y_{Average} (xₒ, I) (=y′ (xₒ, i)), when input signal x is reference input signal xₒ, by making the approximate function to pass through the point (x, z′)=(xₒ, zₒ′). Specifically, the sum total value Σ concerning input signal x is calculated for the value of (|log (z′(x, i))−(a (i) (log (x)−log (xₒ))+log (zₒ′))|), and a value of tilt a (i) for the minimum value of the sum total value Σ is obtained (step S55).

Next, the correction processor 60 calculates reference tilt aₒ of the approximate function (step S56). Specifically, the correction processor 60 first calculates average value Sa of tilt a (i) concerning recording elements 3 which are respectively given numbers of r-s (r and s represent natural numbers), and calculates average value Sn of tilt a (i) concerning recording elements 3 which are respectively given numbers of t-u (t and u represent natural numbers). Then, the correction processor 60 makes a value of Sa to be reference tilt aₒ when Sa and Sn satisfy the following expression (3), and makes a value of Sn to be reference tilt aₒ when Sa and Sn do not satisfy the following expression (3).
Top (a)+Sn>Sa>Bottom (a)+Sn (3)

Incidentally, the number of recording elements 3 per one array is 4000, it is preferable that the number 1500 is used as a value of each of the aforesaid r and t, and the number 2500 is used as a value of each of the aforesaid s and u. Further, in the case of aₒ=1, it is preferable that 1.1 is used as a value of the aforementioned coefficient Top (a) and 0.9 is used as a value of the coefficient Bottom (a).

Then, the correction processor 60 calculates correction coefficient b (i) shown by the following expression (4) (step S57).
b(i)=a(i)/aₒ (4)

Next, when the calculated correction coefficient b (i) satisfies Bottom (b)<b (i)<Top (b), the correction processor 60 stores a value of the calculated correction coefficient b (i) as it is. On the other hand, in the case of Top (b)≦b (i), a value of prescribed upper limit value Top (b) is stored as correction coefficient b (i), and in the case of b (i)≦Bottom (b), a value of prescribed lower limit value Bottom (b) is stored as correction coefficient b (i) (step S58).

In this case, in the case of aₒ=1, it is preferable that 1.05 is used as a value of the aforementioned correction coefficient Top (b) and 0.95 is used as a value of the correction coefficient Bottom (b).

Next, the correction processor 60 multiplies second correction value c (i) calculated previously by b (i) to make the result of the calculation to be new second correction value c (i). In this case, when the calculation of the second correction value c (i) is the first one, a value of the preceding second correction value c (i) is made to be 1 for all recording elements 3.

In the case of Top (c)≦c (i), the correction processor 60 makes a value of the second correction value c (i) to be a value of the prescribed upper limit value Top (c), and in the case of c (i)≦Bottom (c), the correction processor 60 makes a value of the second correction value c (i) to to be a value of the prescribed lower limit value Bottom (c).

In this case, in the case of aₒ=1, it is preferable that 1.1 is used as a value of the aforementioned upper limit value Top (c) and 0.9 is used as a value of the lower limit value Bottom (c).

Then, the correction processor 60 stores the second correction value c (i) by making it to be of the value of the prescribed resolving power and to be in the high-speed-processable state (step S59). Incidentally, the second correction value c (i) thus stored is used in the case of succeeding calculation of the second correction value c (i).

Further, the correction processor 60 corrects input signals by using the calculated first correction value H (i) and second correction value c (i), and outputs images based on the corrected input signals (step S6). By conducting correction by using the first correction value H and the second correction value c (i) as stated above, an input-output function of each recording element 3 is approximated to the reference input-output function, namely, dispersion of input-output characteristics of recording elements 3, is corrected.

In the image outputting method stated above, dispersion of output characteristics of recording elements 3 can be corrected by two correction values including the first correction value H and the second correction value c (i), thereby, the dispersion can be corrected without using the correction value for each output density concerning each recording element 3, which is different from the traditional way. In other words, the dispersion can be corrected by the amount of data which is less than that in the past.

Further, since it is not always necessary to use read-out information at all output densities, it is possible to use only read-out information at output density where measuring accuracy is high. It is therefore possible to conduct correction with correction values which are free from errors, namely, the correction can be made at higher accuracy than in the past.

Further, the first correction value H (i) and the second correction value c (i) do not interact each other because an x-y′ table representing a virtual input-output function is calculated by normalizing an x-y table representing an input-output function of each recording element 3 with reference density y (xₒ, i), and second correction value c (i) is calculated based on the x-y′ table. Therefore, the second correction value c (i) can be calculated either before or after the calculation of the first correction value H (i), in other words, the first correction value H (i) and the second correction value c (i) can be calculated independently. Accordingly, one of the first correction value H (i) and the second correction value c (i) can be changed while the other is fixed, thus, the second correction value c (i) calculated previously can be used for succeeding calculation of the second correction value c (i). Thus, the correction accuracy by means of the second correction value c (i) can be enhanced convergently.

By using a ratio of tilt a (i) of the approximate function of log x-log z′ to reference tilt aₒ for calculating the second correction value c (i), the second correction value c (i) can be calculated more easily, compared with an occasion to use a higher-order coefficient.

It is possible to make the second correction value c (i) to be within the prescribed range, by using the value between the upper limit value Top (c) and the lower limit value Bottom (c) as the second correction value c (i), even in the case, for example, of a contaminated recording medium on which an image is outputted, or of a lower reading accuracy of an image reading apparatus. Therefore, the second correction value c (i) is not dispersed even when calculations are repeated, which makes it possible to prevent that the output density does not correspond to the input signal.

It is possible to correct the dispersion at higher accuracy, by using values obtained from the linear area of x-y_{Average} table, namely, from an area where measuring accuracy of output density is high, as the average reference density y_{Average} (xₒ, I) and reference input signal xₒ, which is different from the occasion where a value obtained from the non-linear area is used. It is further possible to output images which are free from density unevenness visually, because output densities can be made uniform among output elements 3, . . . in the density area where an influence of uneven density is visually great.

Incidentally, in the First Embodiment mentioned above, though the explanation has been given under the condition that a value of reference tilt aₒ is an average of tilt a (i) of log x-log z′ table for each recording element 3, it is also possible to obtain the log x-log z′ table from y′_{Average}-z′ table, and to make a tilt of the log x-log z′ table in this case to be reference tilt aₒ.

Further, though the aforesaid explanation has been given under the condition that the correction is conducted by the first correction value H (i) and the second correction value c (i), it is also possible to arrange so that correction is conducted by the first correction value H (i) and correction coefficient b (i).

Though the aforesaid explanation has been given under the condition that images are outputted on photosensitive printing paper 2 by recording elements 3, it is also possible to arrange to record images on a recording medium such as a sheet of paper by using nozzles, or to output images on a display by using a light-emitting device such as EL element.

### Second Embodiment

Second Embodiment of the invention will be explained next. Incidentally, structural elements in the Second Embodiment which are the same as those in the First Embodiment are given the same symbols, and explanation for them will be omitted.

Image reading apparatus 20 relating to the invention is equipped with flatbed scanner 70 and correction processor (second correction processor) 60A.

The correction processor 60A is one to correct light-receiving characteristics of each CCD 7 of the flatbed scanner 70. This correction processor 60A is arranged to calculate an amount of correction for amount of light-receiving for CCD 7 and thereby to correct read-out information of images. Further, the correction processor 60A stores various parameters necessary for correction, and it stores third correction value G (i) and fourth correction value f (i) which are described later, specifically.

Next, the image reading method relating to the invention will be explained.

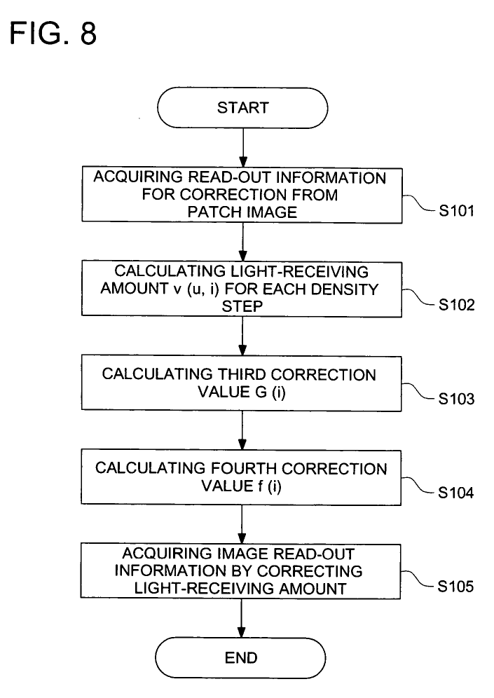

FIG. 8 is a flow chart showing the image reading method in the present embodiment.

As shown in this drawing, in the flatbed scanner 70, the light source emits light, and read-out information for correction is acquired from the reflected light coming from a patch image (image for correction) which is the same as that in FIG. 4 (step S101). Incidentally, the patch image is one that is free from uneven density and is uniform in terms of reflectance and transmittance, in each density step.

Next, the correction processor 60A calculates amount of light-receiving v (u, i) (i represents a number of CCD 7) corresponding to image density u of each density step, based on the following expression (5) (step S102). In the same way, correction processor 60 calculates reference amount of light-receiving v (uₒ, i) (see FIG. 6(b)) of reference density step Tᵤₒ (uₒ is reference image density shown by uₒ=(uₚ+u_{q})/2, and “ₚ” and “_{q}” represent subscripts showing density steps) that is positioned between density step Tₚ and density step T_{q}. This reference amount of light-receiving v (uₒ, i) may also be a virtual density step without being limited to the density step outputted actually;
v(u, i)=−log (S(u, i)/K) (5)
wherein, S (u, i) is average amount of light-receiving data in direction B (see FIG. 4) in each density step.

Next, the correction processor 60A calculates third correction value G (i) for correcting image density u corresponding to average reference amount of light-receiving (reference amount of light-receiving) v_{Average} (uₒ, I) which will be described later into reference image density u₀ (step S103). Incidentally, in the step S103, image density u is a value that satisfies uₚ≦u≦u_{q}.

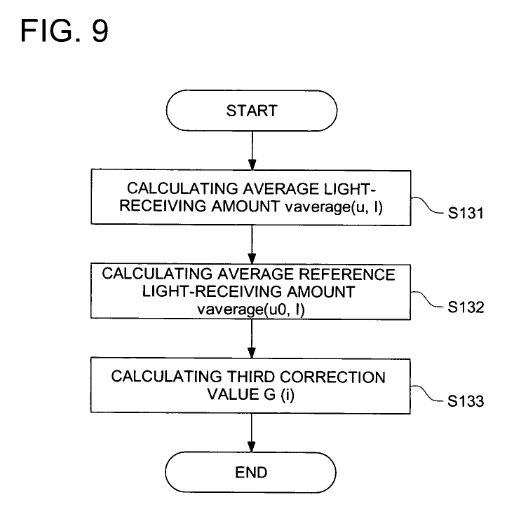

Specifically, as shown in FIG. 9, the correction processor 60A first calculates an average value of amount of light-receiving v (u, i) (hereinafter referred to as average amount of light-receiving) v_{Average} (u, I) (wherein, I represents a subscript showing an average of plural CCD 7) for CCD 7 within a prescribed range in the direction A (see FIG. 4), for each of density steps Tₚ-T_{q} (step S131). Incidentally, the average amount of light-receiving v_{Average} (u, I) may also be an average of amount of light-receiving v (u, i) for all CCD 7.

Next, as shown in FIG. 6(b), the correction processor 60A prepares a u-v_{Average} table and calculates, from the table, a value of average amount of light-receiving VAverage (hereinafter, referred to as average reference amount of light-receiving) corresponding to the reference image density uₒ, interpolatively (step S132). In this case, average reference amount of light-receiving v_{Average} (uₒ, I) and the reference image density uₒ represent a value obtained from a linear area of an u-v_{Average} table described later, namely, a value obtained from an area where accuracy of measuring density by flatbed scanner 70 is high. Incidentally, FIG. 6 (b) illustrates only an u-v table about one CCD 7, for convenience' sake.

Further, the correction processor 60A calculates image density u that corresponds to average reference amount of light-receiving v_{Average} (uₒ, I) about each CCD, by using a u-v table, to make it to be a reference density value (first reference image density) w (uₒ, i). Then, the correction processor 60A calculates third correction value G (i) (=uₒ/w (uₒ, i)) based on the result of the aforesaid calculation (step S133).

After calculating the third correction value G (i), the correction processor 60A calculates fourth correction value f (i) for correcting tilt d (i) of an approximate function of a virtual input-output function in the case of correcting the input-output function of each CCD 7 with the third correction value G (i) as shown in FIG. 8 into the reference tilt dₒ (tilt of reference input-output function) (step S104). Incidentally, in the following steps, image density u is not limited to the value satisfying uₚ≦u≦u_{q}.

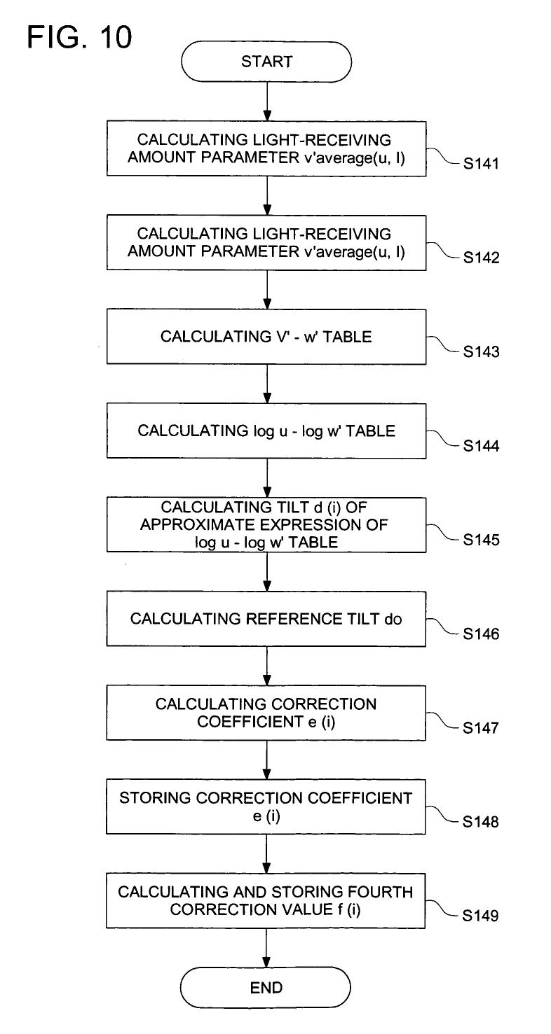

To be concrete, the correction processor 60A first normalizes amount of light-receiving v (u, i) with reference amount of light-receiving v (uₒ i) based on the following expression (6) as shown in FIG. 10, and thereby, calculates normalized amount of light-receiving (hereinafter referred to as an amount of light-receiving parameter) v′ (u, i) (step S141)
v′(u, i)=v(u, i)−v(uₒ, i)+v_{Average}(uₒ, I) (6)

Owing to this, a virtual input-output function in the case of correcting a u-v table representing an input-output function of CCD 7 with the third correction value G (i) is calculated as a u-v′ table.

Then, the correction processor 60A calculates an average value (hereinafter referred to as an average amount of light-receiving parameter) v′_{Average} (u, I) of amount of light-receiving parameter v′ (u, i) concerning CCD 7, within a prescribed range (step S142). Incidentally, average amount of light-receiving parameter v′_{Average} (u, I) may also be an average concerning all CCD 7.

Then, the correction processor 60A calculates a v′-w′ table showing the relationship between the amount of light-receiving parameter v′ and a density value (hereinafter referred to as a density parameter) w′ corresponding to amount of light-receiving parameter v′ (step S143). Further, the correction processor 60A uses this v′-w′ table to calculate density parameter w′ (u, i) corresponding to amount of light-receiving parameter v′ (u, i) of each image density u and each CCD 7. Still further, the correction processor 60A calculates a u-w′ table by replacing amount of light-receiving parameter v′ of the v′-w′ table with image density u concerning each CCD.

Then, the correction processor 60A calculates log u-log w′ table from a u-w′ table concerning each CCD 7 (step S144), and calculates an approximate function (approximate expression) of the log u-log w′ table by the use of the least-squares method. In this case, the amount of light-receiving parameter v′ (u, i) is made to be average reference amount of light-receiving v_{Average} (uₒ, I) (=v′ (uₒ, i)), when image density u is reference image density uₒ, by making the approximate function to pass through the point (u, w′)=(uₒ, wₒ′). Specifically, the sum total value Σ concerning image density u is calculated for the value of (|log (w′(u, i))−(d (i) (log (u)−log (uₒ))+log (wₒ′))|), and a value of tilt d (i) for the minimum value of the sum total value Σ is obtained (step S145).

Next, the correction processor 60A calculates reference tilt dₒ of the approximate function (step S146). Specifically, the correction processor 60A first calculates average value S′a of tilt d (i) concerning CCD 7 which are respectively given numbers of r-s (r and s represent natural numbers), and calculates average value Sn of tilt d (i) concerning CCD 7 which are respectively given numbers of t-u (t and u represent natural numbers) Then, the correction processor 60A makes a value of S′a to be reference tilt dₒ when S∝a and S′n satisfy the following expression (7), and makes a value of S′n to be reference tilt dₒ when S′a and S′n do not satisfy the following expression (7).
Top (d)+Sn>Sd>Bottom (d)+Sn (7)

Incidentally, when the number of CCD 7, . . . per one array is 4000, it is preferable that the number 1500 is used as a value of each of the aforesaid r and t, and the number 2500 is used as a value of each of the aforesaid s and u. Further, in the case of dₒ=1, it is preferable that 1.1 is used as a value of the aforementioned coefficient Top (d) and 0.9 is used as a value of the coefficient Bottom (d).

Then, the correction processor 60A calculates correction coefficient e (i) shown by the following expression (8) (step S147).
e(i)=d(i)/dₒ (8)

Next, when the calculated correction coefficient e (i) is Bottom (e)<e (i)<Top (e), the correction processor 60A stores a value of the calculated correction coefficient e (i) as it is. On the other hand, when it is Top (e)≦e (i), a value of prescribed upper limit value Top (e) is stored as correction coefficient e (i), while, when it is e (i)≦Bottom (e), a value of prescribed lower limit value Bottom (e) is stored as correction coefficient e (i) (step S148).

In this case, in the case of dₒ=1, it is preferable that 1.05 is used as a value of the aforementioned correction coefficient Top (e) and 0.95 is used as a value of the correction coefficient Bottom (e).

Next, the correction processor 60A multiplies second correction value f (i) calculated previously by e (i) to make the result of the calculation to be new fourth correction value f (i). In this case, when the calculation of the fourth correction value f (i) is the first one, a value of the preceding fourth correction value f (i) is made to be 1 for all CCD 7.

In the case of Top (f)≦f (i), the correction processor 60A makes a value of the fourth correction value f (i) to be a value of the prescribed upper limit value Top (f), and in the case of f (i)≦Bottom (f), the correction processor 60 makes a value of the fourth correction value f (i) to be a value of the prescribed lower limit value Bottom (f).

In this case, in the case of dₒ=1, it is preferable that 1.1 is used as a value of the aforementioned upper limit value Top (f) and 0.9 is used as a value of the lower limit value Bottom (f).

Then, the correction processor 60A stores the fourth correction value f (i) by making it to be of the value of the prescribed resolving power and to be in the high-speed-processable state (step S49). Incidentally, the fourth correction value f (i) thus stored is used in the case of succeeding calculation of the fourth correction value f (i).

Further, the correction processor 60A corrects an amount of light-receiving for CCD 7 by using the third correction value G (i) and fourth correction value f (i), and acquires image read-out information by correcting measurement density (step S105). By conducting correction by using the third correction value H and the fourth correction value f (i) as stated above, an input-output function of each CCD 7 is approximated to the reference input-output function, namely, dispersion of input-output characteristics of CCD 7, is corrected.

One embodiment of the present invention is an image reading method to obtain a correction amount for measurement density by each light-receiving element and to acquire image read-out information by using the correction amount, by emitting light from a light source and thereby acquiring read-out information for correction from reflected light from images for correction with plural densities by using plural light-receiving elements, wherein third correction value to correct the first reference image density corresponding to the prescribed reference amount of light-receiving to the prescribed second reference image density, for each light-receiving element by using the read-out information for correction, and the fourth correction value to correct the approximate function obtained from the virtual input-output function showing input-output characteristic in the case of correction by the third correction value under the condition that the image density turns out to be the second reference image density when the amount of light-receiving is the reference amount of light-receiving to the prescribed reference input-output function are calculated, and the third correction value and the fourth correction value are used to acquire image read-out information by correcting the measurement density of the light-receiving element.

According to the embodiment of the present invention described above, by using the third correction value and the fourth correction value for correction of measurement density, the input-output function of the light-receiving element is approximated to the reference input-output function, namely, the dispersion of the light-receiving characteristic of the light-receiving element is corrected. Accordingly, by using two correction values including the third correction value and the fourth correction value for each light-receiving element, the dispersion can be corrected, thereby, the dispersion can be corrected without using the correction value of each image density for each light-receiving element, which is different from a manner in the past. In other words, the dispersion can be corrected by the amount of data which is less than that in the past.

Further, it is possible to use only read-out information for correction at the density where the measurement accuracy is high, because it is not necessary to use read-out information at all densities, which is different from a manner in the past. It is therefore possible to conduct correction with correction values which are free from errors, namely, the correction can be made at higher accuracy than in the past.

In the image read-out method stated above, dispersion of characteristics light-receiving for CCD 7 can be corrected by using two correction values including the third correction value G (i) and the fourth correction value f (i) for each CCD 7, thereby, the aforesaid dispersion can be corrected without using the correction value for each image density concerning each CCD 7, which is different from the traditional way. In other words, the dispersion can be corrected by the amount of data which is less than that in the past.

Further, since it is not always necessary to use read-out information at all densities, which is different from the past, it is possible to use only read-out information for correction at density where measuring accuracy is high. It is therefore possible to conduct correction with correction values which are free from errors, namely, the correction can be made at higher accuracy than in the past.

Further, a value of the third correction value G (i) and a value of the fourth correction value f (i) do not interact each other because a u-v′ table representing a virtual input-output function is calculated and the fourth correction value f (i) is calculated based on the u-v′ table, by normalizing a u-v table representing an input-output function of each CCD 7 with reference amount of light-receiving v (uₒ, i). Therefore, the fourth correction value f (i) can be calculated either before or after the calculation of the third correction value G (i), in other words, the third correction value G (i) and the fourth correction value f (i) can be calculated independently. Accordingly, one of the third correction value G (i) and the fourth correction value f (i) can be changed while the other is fixed, thus, the fourth correction value f (i) calculated previously can be used for succeeding calculation of the fourth correction value f (i). Thus, the correction accuracy by means of the fourth correction value f (i) can be enhanced convergently.

By using a ratio of tilt d (i) of the approximate function of log u-log w′ to reference tilt dₒ for calculation of the fourth correction value f (i), the fourth correction value f (i) can be calculated more easily, compared with an occasion to use a higher-order coefficient.

It is possible to make the second correction value to be within the prescribed range, by using the value between the upper limit value Top (f) and the lower limit value Bottom (f) as the fourth correction value f (i), even in the case, for example, of a contaminated patch images. Therefore, it is possible to arrange so that the fourth correction value f (i) may not be dispersed even when calculations are repeated, which makes it possible to prevent that the measurement density does not correspond to the image density.

It is possible to correct the dispersion at higher accuracy, by using values obtained from the linear area of u-v_{Average} table, namely, from an area where measuring accuracy of density is high, as the average reference amount of light-receiving v_{Average} (uₒ, I) and reference image density uₒ, which is different from the occasion where a value obtained from the non-linear area is used.

Incidentally, in the second embodiment mentioned above, though the explanation has been given under the condition that a value of reference tilt dₒ is an average of tilt d (i) of log u-log w′ table for each CCD 7, it is also possible to obtain the log u-log w′ table from v′_{Average}-w′ table, and to make a tilt of the log u-log w′ table in this case to be reference tilt dₒ.

Further, though the aforesaid explanation has been given under the condition that the correction is conducted by the third correction value G (i) and the fourth correction value f (i), it is also possible to arrange so that correction is conducted by the third correction value g (i) and correction coefficient e (i).

1. An image outputting apparatus, comprising:
a plurality of outputting elements for outputting a correction image;
an image reading apparatus for obtaining read-out information from the correction image; and
a first correction processor for obtaining a correction amount of an output density of each outputting element of the plurality of outputting elements based on the reading information,
wherein the first correction processor calculates
a first correction value to be used for correcting a first reference input signal corresponding to a predetermined reference output density to a predetermined second reference input signal of the outputting element and
a second correction value to be used for correcting an approximation function to a reference input-output function, the approximation function being obtained from a virtual input-output function showing an input-output characteristic of the outputting element, the input-output characteristic being corrected by the first correction value, under a condition that an output density of the outputting element turns out to be the reference output density when an input signal to the outputting element is the second reference signal, and
corrects the input signal by using the first correction value and the second correction value.

2. The image outputting apparatus of claim 1,
wherein the first correction processor calculates the virtual input-output function by normalizing an input-output function showing an input-output characteristic of each outputting element of the plurality of outputting elements based on outputting density corresponding to the first reference input signal.

3. The image outputting apparatus of claim 1,
wherein the first correction processor stores the second correction value which has been calculated, the second correction value which has been stored being used for a succeeding calculation of the second correction value.

4. The image outputting apparatus of claim 2,
wherein the first correction processor stores the second correction value which has been calculated, the second correction value which has been stored is used for succeeding calculation of the second correction value.

5. The image outputting apparatus of claim 3,
wherein the second correction value is a value obtained by multiplying the second correction value which has been calculated by a ratio of a tilt of the approximate function to a tilt of linear area of the reference input-output function.

6. The image outputting apparatus of claim 4,
wherein the second correction value is a value obtained by multiplying the second correction value which has been calculated by a ratio of a tilt of the approximate function to a tilt of linear area of the reference input-output function.

7. The image outputting apparatus of claim 1,
wherein the second correction value represents a ratio of a tilt of the approximate function to a tilt of the reference input-output function.

8. The image outputting apparatus of claim 2,
wherein the second correction value represents a ratio of a tilt of the approximate function to a tilt of the reference input-output function.

9. The image outputting apparatus of claim 1,
wherein the approximate function is logarithmically converted from an exponential function, the first correction value represents a constant term of the approximate function and the second correction value represents a proportional term of the approximate function.

10. The image outputting apparatus of claim 2,
wherein the approximate function is logarithmically converted from an exponential function, the first correction value represents a constant term of the approximate function and the second correction value represents a proportional term of the approximate function.

11. The image outputting apparatus of claim 1,
wherein the second reference input signal and the reference output density represent a value obtained from linear area of the reference input-output function.

12. The image outputting apparatus of claim 2,
wherein the second reference input signal and the reference output density represent a value obtained from linear area of the reference input-output function.

13. The image outputting apparatus of claim 3,
wherein the second reference input signal and the reference output density represent a value obtained from linear area of the reference input-output function.

14. The image outputting apparatus of claim 5,
wherein the second reference input signal and the reference output density represent a value obtained from linear area of the reference input-output function.

15. The image outputting apparatus of claim 7,
wherein the second reference input signal and the reference output density represent a value obtained from linear area of the reference input-output function.

16. The image outputting apparatus of claim 9,
wherein the second reference input signal and the reference output density represent a value obtained from linear area of the reference input-output function.

17. The image outputting apparatus of claim 1,
wherein the outputting element is a light-emitted element for recording an image on a photosensitive material.

18. The image outputting apparatus of claim 2,
wherein the outputting element is a light-emitted element for recording an image on a photosensitive material.

19. The image outputting apparatus of claim 3,
wherein the outputting element is a light-emitted element for recording an image on a photosensitive material.

20. The image outputting apparatus of claim 5,
wherein the outputting element is a light-emitted element for recording an image on a photosensitive material.

21. The image outputting apparatus of claim 7,
wherein the outputting element is a light-emitted element for recording an image on a photosensitive material.

22. The image outputting apparatus of claim 9,
wherein the outputting element is a light-emitted element for recording an image on a photosensitive material.

23. The image outputting apparatus of claim 11,
wherein the outputting element is a light-emitted element for recording an image on a photosensitive material.
